(19) United States
(12) Patent Application Publication
(10) Pub. No.: US 2013/0220261 A1
(43) Pub. Date: Aug. 29, 2013

(54) VARIABLE INTAKE DEVICE OF ENGINE

(71) Applicant: HYUNDAI MOTOR COMPANY, (US)

(72) Inventors: Tae Min Yun, Anyang-si (KR); Se Il Kim, Suwon-si (KR)

(73) Assignee: HYUNDAI MOTOR COMPANY, Seoul (KR)

(21) Appl. No.: 13/661,696

(22) Filed: Oct. 26, 2012

(30) Foreign Application Priority Data
Feb. 29, 2012 (KR) 10-2012-0021075

(51) Int. Cl. F02M 35/10

(52) U.S. Cl. 123/184.56

(57) ABSTRACT

A variable intake device of an engine may include an auxiliary intake duct that may be disposed with one end thereof inserted inside an air cleaner and sucks air, and a magnetic variable valve that may be disposed at the one end of the auxiliary intake duct positioned inside the air cleaner to selectively open or close the auxiliary intake duct so that as intake negative pressure increases, an open angle of the magnetic variable valve increases.

### CROSS-REFERENCE TO RELATED APPLICATION

The present application claims priority to Korean Patent Application No. 10-2012-0021075 filed Feb. 29, 2012 the entire contents of which is incorporated herein for all purposes by this reference.

### BACKGROUND OF THE INVENTION

1. Field of the Invention

The present disclosure relates to a variable intake device of an engine. More particularly, it relates to a variable intake device of an engine that can adjust the amount of air supplied into a combustion chamber in accordance with the RPM of the engine.

2. Description of Related Art

As shown in FIG. 1, in general, fresh air (external air) is supplied into the combustion chamber of an engine sequentially through an intake duct 1, an air cleaner 2, and an intake hose 3 in the intake stroke of the engine piston, and the intake duct 1 is equipped with a resonator 4 for reducing intake noise.

In particularly, a lager amount of fresh air should be supplied into the combustion chamber to increase the output in a high-output engine (turbocharger and high-RPM engine), and for this configuration, the diameter, that is, the cross-sectional area of the intake duct 1 and the intake hose 3 is increased or the fresh air supply root to the combustion chamber is simplified by decreasing the length.

However, there is a limit in increasing the diameter, that is, the cross-sectional area of the intake duct 1 or the intake hose 3 due to a small layout of the engine room, and when the length of the intake duct 1 or the intake hose 32 is made short, the combustion noise of the engine is easily transmitted to the outside through the intake system so that the intake noise increases, and thus, the commercial value of a vehicle decreases.

Further, there is a method of increasing the number of the resonators 4 or increasing the capacity thereof in order to reduce the intake noise after decreasing the length of the intake duct 1 or the intake hose 3, but the weight and the manufacturing cost increase in this case.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a variable intake device for an engine that can adjust the amount of air supplied into a combustion chamber in accordance with the RPM of an engine by disposing an auxiliary intake duct in an air cleaner so that a large amount of fresh air is supplied into the combustion chamber through an auxiliary intake duct when the engine operates with high RPM, and that can increase the output of the engine without changing the layout of the engine room and increasing the weight, manufacturing cost, and intake noise.

In an aspect of the present invention, a variable intake device of an engine, may include an auxiliary intake duct that is disposed with one end thereof inserted inside an air cleaner and sucks air, and a magnetic variable valve that is disposed at the one end of the auxiliary intake duct positioned inside the air cleaner to selectively open or close the auxiliary intake duct so that as intake negative pressure increases, an open angle of the magnetic variable valve increases.

The variable intake device may include an intake duct that is connected to the air cleaner and sucks air, an intake hose that is connected to the air cleaner and guides the air passing through the air cleaner into a combustion chamber, and a resonator that is disposed in the intake duct and connected to the air cleaner to reduce intake noise.

The auxiliary intake duct is made of porous non-woven fabric to reduce intake noise when the engine operates with high RPM.

The magnetic variable valve is rotatably coupled to the one end of the auxiliary intake duct which is positioned in the air cleaner.

A plurality of protrusions integrally protrudes from an inner side of the air cleaner such that the magnetic variable valve is positioned at the middle in the length direction of the air cleaner, in the air cleaner, and a plurality of duct flanges through which the protrusions are fitted integrally protrudes from an outer circumference of the auxiliary intake duct.

The auxiliary intake duct is made shorter than the intake duct.

The magnetic variable valve may include a valve plate pivotally coupled to the one end of the auxiliary intake duct by a rotary shaft to be rotatable thereabout, a first permanent magnet fixed to the one end of the auxiliary intake duct, and a second permanent magnet fixed to the valve plate.

The magnetic variable valve may further include a valve pad member fitted on an outer circumference of the valve plate to seal a gap between the one end of the auxiliary intake duct and the valve plate so as to remove operational noise of the valve plate.

The valve pad member is made of elastic rubber or plastic synthetic resin.

The first permanent magnet and the second permanent magnet are aligned to generate an attractive force to each other.

The first permanent magnet and the second permanent magnet are each equipped with a magnet cover respectively and an opening time of the magnetic variable valve is tuned by adjusting the thicknesses of each magnet cover.

A sealer is fitted on an outer circumference of the auxiliary intake duct to be positioned where the auxiliary intake duct is fitted in the air cleaner.

The sealer is made of a thermoplastic elastomer by injection molding.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view showing an intake system through which a fresh air is supplied into an engine in the related art.

FIG. 2 is a perspective view of a variable intake device equipped with an auxiliary intake duct and a magnetic variable valve according to an exemplary embodiment of the present invention.

FIG. 3 is an enlarged view of the air cleaner shown in FIG. 2.

FIG. 4 is a cross-sectional view of FIG. 3.

FIG. 5 is a view showing the inside of the air cleaner equipped with the auxiliary intake duct and the magnetic variable valve according to an exemplary embodiment of the present invention.

FIG. 6 is an exploded perspective view of the auxiliary intake duct and the magnetic variable valve according to an exemplary embodiment of the present invention.

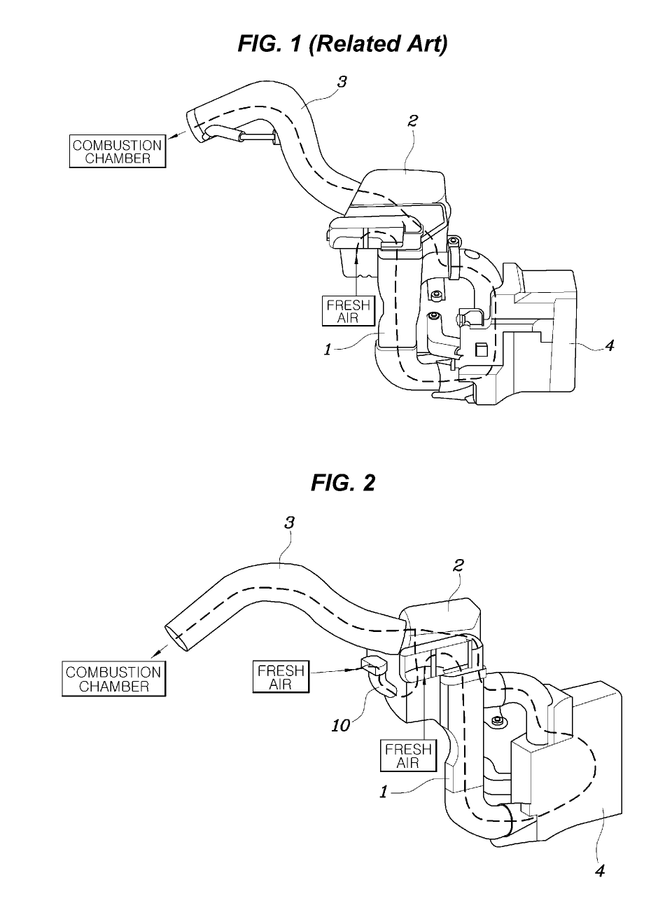

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter reference will now be made in detail to various embodiments of the present invention, examples of which are illustrated in the accompanying drawings and described below.

A variable intake device of an engine according to an exemplary embodiment of the present invention is described hereafter with reference to the accompanying drawings.

An intake device of an engine that sucks fresh air (external air) into an engine combustion chamber in an intake stroke of an engine piston, shown in FIG. 2, includes an intake duct 1 for sucking fresh air, an air cleaner 2 that filters foreign substances contained in the fresh air, an intake hose 3 that guides the air with foreign substances filtered into the combustion chamber, and a resonator 4 that is disposed in the intake duct 1 to reduce intake noise.

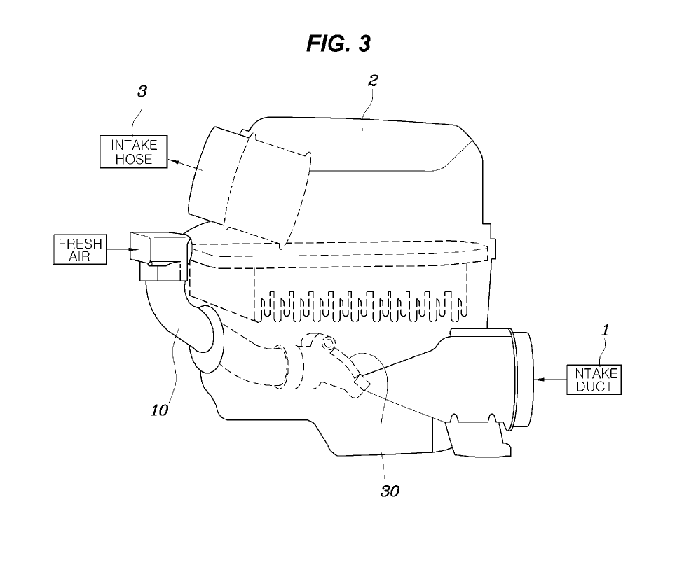

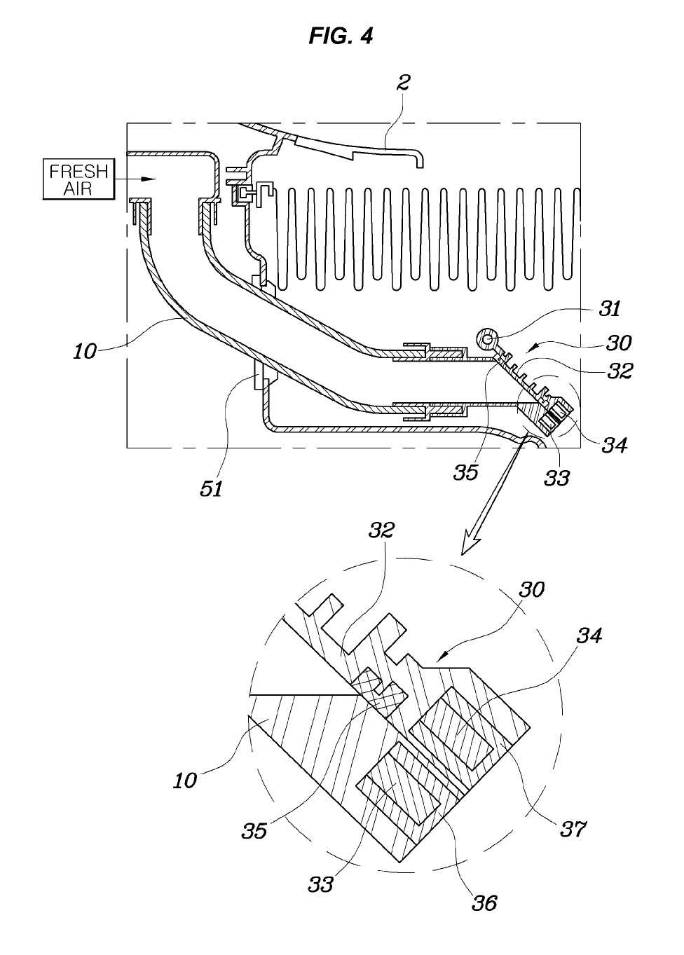

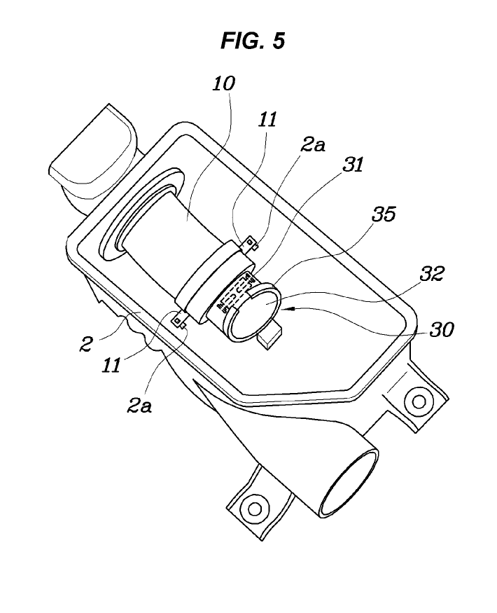

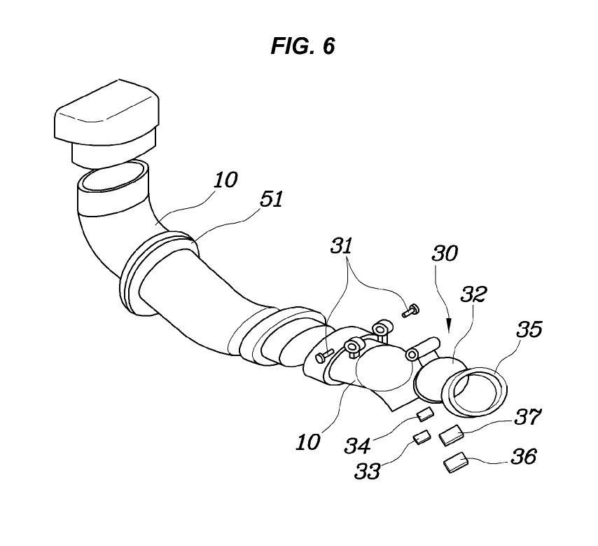

Further, the present invention provides a variable intake device for sucking a larger amount of fresh air in order to increase the output when an engine operates with high RPM and the variable intake device according to an exemplary embodiment of the present invention includes, as shown in FIGS. 2 to 6, an auxiliary intake duct 10 that is disposed with one end inside the air cleaner 2 and sucks fresh air and a magnetic variable valve 30 that is disposed in the auxiliary intake duct 10 positioned inside the air cleaner 2 to open/close the auxiliary intake duct 10 such that as intake negative pressure increases, the open angle increases.

That is, the magnetic variable valve opens the auxiliary intake duct 10 exactly when the negative pressure applied to the valve with the increase in intake negative pressure becomes larger than an attractive force of a magnet.

Therefore, fresh air is supplied into the combustion chamber of an engine sequentially through the intake duct 1, the air cleaner 2, and the intake hose 3, in which the engine combustion noise is sufficiently reduced by the resonator 4 when the engine operates with low RPM so that there is little intake noise that is transmitted to the outside through the intake system.

Further, the fresh air sucked through the intake duct 1 and a first root of the air cleaner 2 and the fresh air sucked through the auxiliary intake duct 10 and a second root of the air cleaner 2 are supplied in a mixture into the combustion chamber of the engine when the engine operates with high RPM such that a larger amount of fresh air is supplied into the combustion chamber when the engine operates with high RPM than when the engine operates with low RPM, and accordingly, it is possible to increase the output of a high-output engine.

It is difficult to sufficiently reduce the engine combustion noise generated when the engine operates with high RPM only with the existing resonator 4, and the intake noise may be generated and thus the present invention provides a configuration of reducing the intake noise with the auxiliary intake duct 10, and for this configuration, it is preferable that the auxiliary intake duct 10 is made of soft and porous non-woven fabric.

Since soft non-woven fabric is excellent in absorbing and dispersing noise, it can sufficiently reducing the intake noise even through an engine operates with high RPM.

Further, instead of non-woven fabric, textile such as wool or cotton cloth, or porous or microporous textile may be used.

The magnetic variable valve 30 closes the auxiliary intake duct 10 when the engine operates with low RPM and opens the auxiliary intake duct 10 only when the engine operates with high RPM.

That is, the magnetic variable valve 30 increases the angle of opening the auxiliary intake duct 10, as the intake pressure increases, that is, the RPM of the engine increases.

The magnetic variable valve 30 is rotatably disposed at the end of the auxiliary intake duct 10, and preferably, the magnetic variable valve 30 is rotatably disposed at the end of the auxiliary intake duct 10 which is positioned in the air cleaner 2 in order to maximally prevent contact of foreign substances without being exposed to the outside (which improves the appearance).

That is, a plurality of protrusions 2a integrally protrudes from the inner side of the air cleaner 2 such that the magnetic variable valve 30 can be positioned at the middle in the longitudinal direction of the air cleaner 2, in the air cleaner 2, and a plurality of duct flanges 11 through which the protrusions 2a are fitted integrally protrudes from the outer circumference of the auxiliary intake duct 10.

Therefore, as the duct flanges 11 are fitted onto the protrusions 2a, the magnetic variable valve 30 disposed at the end of the auxiliary intake duct 10 is positioned at substantially the middle in longitudinal direction of the air cleaner 2, in the air cleaner 2.

As the magnetic variable valve 30 is disposed at the middle position in the air cleaner 2, it can more sensitively react to the intake negative pressure so that more smooth operation thereof can be achieved.

The auxiliary intake duct 10 is made shorter than the intake duct 1, which is for allowing the auxiliary intake duct 10 to suck a larger amount of fresh air than the intake duct 1 so that the output can be increased even through the engine operates with high RPM.

A sealer 51 made of a TPE (Thermoplastic elastomer) by injection molding is fitted on the outer circumference of the auxiliary intake duct 10 to be positioned where the auxiliary intake duct 10 is fitted in the air cleaner 2 in order to keep airtightness.

On the other hand, the magnetic variable valve 30 includes a valve plate 32 disposed at the end of the auxiliary intake duct 10 to be rotatable by a rotary shaft 31, a permanent magnet 33 for a duct fixed to the auxiliary intake duct 10, a permanent magnet 34 for a valve fixed to the valve plate 32, and a valve pad member 35 fitted on the outer circumference of the valve plate 32 to remove a gap between the auxiliary intake duct 10 and the valve plate 32 and operational noise of the valve plate 32.

The valve pad member 35 is made of elastic rubber or plastic synthetic resin, but is not limited thereto.

Further, it is preferable that the permanent magnet 33 for a duct and the permanent magnet 34 for a valve are disposed to generate an attractive force to each other, the permanent magnet 33 for a duct and the permanent magnet 34 for a valve are equipped with magnet covers 36, 37, respectively, and the opening time of the magnetic variable valve 30 can be tuned by adjusting the thicknesses of the magnet covers 36, 37.

That is, since the thicker the magnet covers 36, 37, the more the attractive force between the permanent magnet 33 for a duct and the permanent magnet 34 for a valve decreases, whereas the thinner the magnet covers 36, 37, the more the attractive force between the permanent magnet 33 for a duct and the permanent magnet 34 for a valve increases, it is possible to tune the opening time of the magnetic variable valve 30 by adjusting the thicknesses of the magnet covers 36, 37.

Therefore, since the variable intake device of an engine according to an exemplary embodiment of the present invention makes it possible to suck a large amount of fresh air into the combustion chamber of an engine through the auxiliary intake duct 10 without changing the layout of the engine room and increasing the weight and the manufacturing cost when the engine operates with high RPM, it is possible to increase the output of the engine and particularly remove intake noise that is generated when the engine operates with high RPM, using the auxiliary intake duct 10.

According to an exemplary embodiment of the present invention, it is possible to increase the output of an engine by sucking a large amount of fresh air into the combustion chamber of an engine through an auxiliary intake duct without changing the layout of an engine room, increasing the weight and the manufacturing cost, and generating intake noise, when the engine operates with high RPM.

For convenience in explanation and accurate definition in the appended claims, the terms “upper”, “lower”, “inner” and “outer” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A variable intake device of an engine, comprising;
an auxiliary intake duct that is disposed with one end thereof inserted inside an air cleaner and sucks air; and
a magnetic variable valve that is disposed at the one end of the auxiliary intake duct positioned inside the air cleaner to selectively open or close the auxiliary intake duct so that as intake negative pressure increases, an open angle of the magnetic variable valve increases.

2. The variable intake device of claim 1, further comprising:
an intake duct that is connected to the air cleaner and sucks air;
an intake hose that is connected to the air cleaner and guides the air passing through the air cleaner into a combustion chamber; and
a resonator that is disposed in the intake duct and connected to the air cleaner to reduce intake noise.

3. The variable intake device of claim 1, wherein the auxiliary intake duct is made of porous non-woven fabric to reduce intake noise when the engine operates with high RPM.

4. The variable intake device of claim 1, wherein the magnetic variable valve is rotatably coupled to the one end of the auxiliary intake duct which is positioned in the air cleaner.

5. The variable intake device of claim 1, wherein a plurality of protrusions integrally protrudes from an inner side of the air cleaner such that the magnetic variable valve is positioned at the middle in the length direction of the air cleaner, in the air cleaner, and
a plurality of duct flanges through which the protrusions are fitted integrally protrudes from an outer circumference of the auxiliary intake duct.

6. The variable intake device of claim 2, wherein the auxiliary intake duct is made shorter than the intake duct.

7. The variable intake device of claim 1, wherein the magnetic variable valve includes:
a valve plate pivotally coupled to the one end of the auxiliary intake duct by a rotary shaft to be rotatable thereabout;
a first permanent magnet fixed to the one end of the auxiliary intake duct; and
a second permanent magnet fixed to the valve plate.

8. The variable intake device of claim 7, wherein the magnetic variable valve further includes a valve pad member fitted on the outer circumference of the valve plate to seal a gap between the one end of the auxiliary intake duct and the valve plate so as to remove operational noise of the valve plate.

9. The variable intake device of claim 8, wherein the valve pad member is made of elastic rubber or plastic synthetic resin.

10. The variable intake device of claim 7, wherein the first permanent magnet and the second permanent magnet are aligned to generate an attractive force to each other.

11. The variable intake device of claim 7, wherein the first permanent magnet and the second permanent magnet are each equipped with a magnet cover respectively and an opening time of the magnetic variable valve is tuned by adjusting the thicknesses of each magnet cover.

12. The variable intake device of claim 1, wherein a sealer is fitted on an outer circumference of the auxiliary intake duct to be positioned where the auxiliary intake duct is fitted in the air cleaner.

13. The variable intake device of claim 1, wherein the sealer is made of a thermoplastic elastomer by injection molding.
